(19) United States
(12) Patent Application Publication
(10) Pub. No.: US 2010/0277660 A1
(43) Pub. Date: Nov. 4, 2010

(54) WIRE GRID POLARIZER WITH COMBINED FUNCTIONALITY FOR LIQUID CRYSTAL DISPLAYS

(76) Inventor: Michael J. Little, Garden Valley, CA (US)

Correspondence Address: LUMEN PATENT FIRM, 350 Cambridge Avenue, Suite 100, PALO ALTO, CA, 94306, US

(21) Appl. No.: 12/733,035

(22) PCT Filed: Jul. 24, 2008
(86) PCT No.: PCT/US08/71079

§ 371 Date: Apr. 26, 2010

Related U.S. Application Data
(60) Provisional application No. 60/953,652, filed on Aug. 2, 2007.
(60) Provisional application No. 60/953,658, filed on Aug. 2, 2007.
(60) Provisional application No. 60/953,668, filed on Aug. 2, 2007.
(60) Provisional application No. 60/953,671, filed on Aug. 2, 2007.

(51) Int. Cl. G02F 1/136; G02F 1/1335; G02B 5/30

(52) U.S. Cl. 349/43; 349/62; 349/64; 359/486

(57) ABSTRACT

A combined functionality film may include a wire gird polarizer formed onto a surface of the retarder or compensation film. The wire grid polarizer is configured to transmit light of a desired polarization and reflect light of an undesired polarization. The retarder film or compensation film is configured to increase an angular viewing angle for a liquid crystal display. Such a combined functionality film may be incorporated into a liquid crystal display (LCD) or LCD panel assembly.

### CLAIM OF PRIORITY

This application claims the benefit of priority of U.S. Provisional Patent Application No. 60/953,668, filed Aug. 2, 2008, the entire contents of which are incorporated herein by reference.

This application claims the benefit of priority of U.S. Provisional Patent Application No. 60/953,652, filed Aug. 2, 2008, the entire contents of which are incorporated herein by reference.

This application claims the benefit of priority of U.S. Provisional Patent Application No. 60/953,658, filed Aug. 2, 2008, the entire contents of which are incorporated herein by reference.

This application claims the benefit of priority of U.S. Provisional Patent Application No. 60/953,671, filed Aug. 2, 2008, the entire contents of which are incorporated herein by reference.

### CROSS-REFERENCE TO RELATED APPLICATIONS

This application is related to International Patent Application PCT ______, (Attorney Docket Number AGT-004/PCT, to Michael J. Little, entitled “NANOEMBOSSED SHAPES AND FABRICATION METHODS OF WIRE GRID POLARIZERS”, filed the same day as the present application, the entire contents of which are incorporated herein by reference.

This application is related to International Patent Application PCT ______, (Attorney Docket Number AGT-006/PCT, to Michael J. Little, entitled “A METHOD FOR OBLIQUE VACUUM DEPOSITION FOR ROLL-ROLL COATING OF WIRE GRID POLARIZER LINES ORIENTED IN A DOWN-WEB DIRECTION”, filed the same day as the present application, the entire contents of which are incorporated herein by reference.

### FIELD OF THE INVENTION

Embodiments of the present invention relate generally to direct view liquid crystal displays (LCDs) and more specifically to an LCD that uses wire grid polarizers embedded on compensation films or retarder films to achieve wide viewing angles, while reducing LCD thickness, assembly complexity, and costs.

### BACKGROUND OF THE INVENTION

Liquid crystal displays (LCDs) have recently emerged to become the dominant display technology for applications ranging from cell phones to large screen TVs. This dominant position has been enabled through numerous innovations introduced to overcome the initial limitations of LCDs. A basic LCD assembly consists of a backlight assembly and an LCD panel assembly. The backlight assembly creates a bright, uniform illumination for the LCD panel assembly. The LCD panel assembly first disposes of illumination with an undesired plane of polarization either by absorption or reflection and passes through illumination of a desired plane of polarization. The LCD panel assembly then modulates the illumination of a desired plane of polarization on a pixel-by-pixel basis in proportion to the voltage applied to each pixel of the LCD panel assembly.

The major issues with LCDs involve contrast, brightness, thickness, assembly complexity, and cost. Contrast, as used herein, refers to the ratio of intensity of the transmitted light with a desired plane of polarization to intensity of the transmitted light with an orthogonal plane of polarization. Because the human eye is very discerning, a high contrast ratio is desired (e.g. several thousand to one). Brightness, as used herein, refers to the amount of light emanating from the backlight assembly that reaches the viewer. Typically, an LCD using an LCD panel assembly that absorbs light of an unwanted polarization loses more than 50% of the brightness emanating from the backlight assembly, which reduces the quality of the image seen by the viewer. Depending on the number of structures present in the LCD panel display, the LCD may vary in thickness. A thinner LCD is desirable because of its ability to save space. The assembly complexity and cost go hand in hand, with more components equaling higher costs. By reducing the complexity of the LCD (i.e., the number of components), we not only reduce the thickness of the LCD, but also the assembly complexity and the cost. There are many display modes used in LCDs, but the most popular is the twisted nematic display mode. However, the twisted nematic display mode has inherent problems with viewing the display at angles other than normal incidence. The contrast ratio remains uniform at all azimuthal angles when viewing the LCD at normal incidence. However when the viewing angle is not at normal incidence, the LCD contrast ratio falls off dramatically at many azimuthal angles, and hence the viewer is subjected to a low quality image from the LCD. Other LCD display modes, such as optically compensated birefringence (OCB) mode, in plane switching (IPS) mode, and Vertical Alignment (VA) have their own distinct viewing angle problems, although not as severe as those of the twisted nematic display.

Viewing angle limitations of these different LCD modes have been overcome by adding to the LCD birefringent films known as compensation films or retarder films (see for example U.S. Pat. Nos. 5,344,916; 5,657,140; and 6,512,561, all of which are incorporated herein by reference). The dramatic drop-off in LCD contrast ratio associated with viewing LCDs at angles other than normal incidence is greatly reduced with the addition of these compensation/retarder films. While the addition of these compensation/retarder films greatly improves the angular viewing problems of LCDs, the additions also undesirably increase the cost, complexity, and thickness of the LCD display.

The brightness limitations caused by the rear absorptive polarizer can be compensated for through the use of a technique known as polarization recycling. In polarization recycling, a polarization recycling film is added to the LCD, and is configured to recycle light of an undesired polarization into light of a desired polarization such that a greater percentage of the initial light emanating from the backlight assembly is able to reach the viewer. Again, the addition of this polarization recycling film will increase the cost, complexity, and thickness of our LCD.

Thus, there is a need for a method that simultaneously provides brightness improvements via polarization recycling, viewing angle improvements through the use of compensation films and high contrast polarization while minimizing the cost, complexity and increased thickness in LCDs that result from the current methods.

### BRIEF DESCRIPTION OF THE DRAWINGS

FIG. 1 illustrates the construction of a typical LCD.

FIG. 2 illustrates the operation of a twisted nematic LCD.

FIG. 3A depicts a coordinate system used to analyze contrast ratio.

FIG. 3B is a contrast ratio diagram for a twisted nematic LCD viewed at normal incidence.

FIG. 3C is a contrast ratio diagram for a twisted nematic LCD viewed at a viewing angle other than normal incidence.

FIG. 4 schematically illustrates the construction of a typical LCD with viewing angle compensation layers added.

FIGS. 5A-5B depict improved angular viewing characteristics of a typical twisted nematic LCD when viewing angle compensation films are used in conjunction with an LCD.

FIG. 6 illustrates the principle of polarization recycling in LCDs.

FIG. 7 illustrates the construction of a typical LCD with a polarization recycling film added.

FIG. 8 illustrates one embodiment of this invention.

FIG. 9 illustrates an example of the construction of an LCD using one embodiment of the present invention on the rear side of an LCD assembly.

FIG. 10 illustrates another example of an LCD using one embodiment of the present invention on both the front and back of an LCD assembly.

### DETAILED DESCRIPTION OF THE SPECIFIC EMBODIMENTS

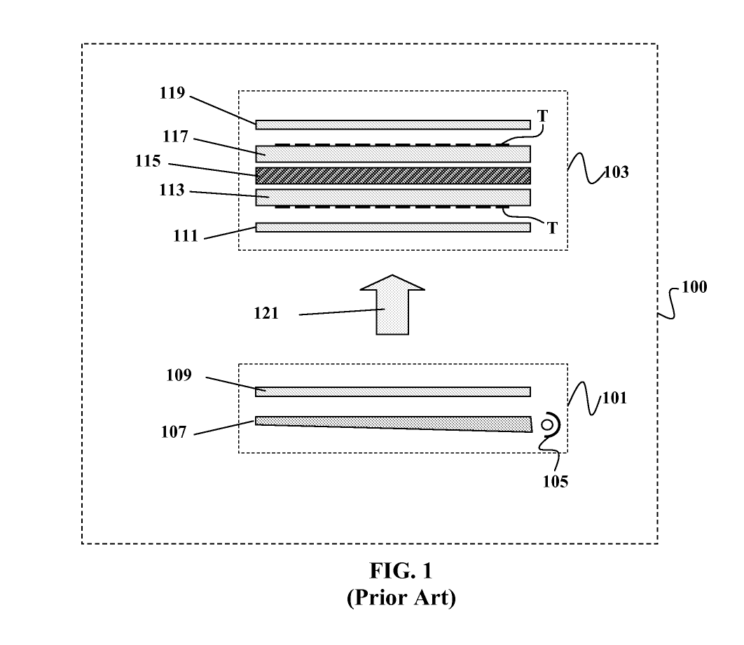

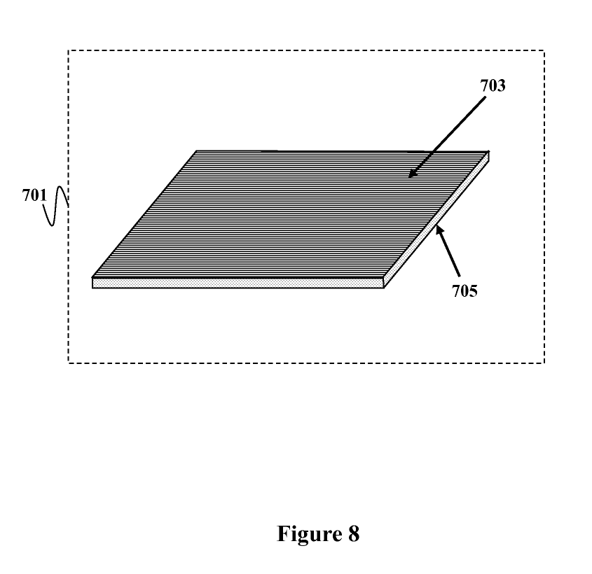

The general purpose of embodiments of the present invention is to reduce the cost, complexity and thickness of LCDs yet provide (1) the desired wide viewing angles afforded with compensation films, (2) the desired polarization recycling brightness enhancement and (3) the desired high contrast polarizing function in one single thin film. To understand the limitations of current LCDs, FIGS. 1-7 will be used to describe prior art. FIGS. 8-10 will be used to illustrate certain embodiments of the present invention.

FIG. 1 illustrates a cross-section of a typical LCD assembly. The LCD assembly 100 consists of a backlight unit 101 and an LCD panel assembly 103. Within the backlight unit 101 is a light source 105, a light guide 107, and a diffuser 109. The light source 105 provides illumination, which is directed towards the diffuser 109 by the light guide 107. The diffuser 109 is configured to homogenize the spatial variations in the intensity of the light emanating from the light source 105. The illumination provided by the backlight unit 101 is unpolarized light 121. After the unpolarized light 121 leaves the backlight unit 101, it becomes incident on the LCD panel assembly 103. The LCD panel assembly 103 consists of a rear absorptive polarizer 111; transparent plates 113, 117 (e.g., made of glass or another suitable material); a liquid crystal layer 115 disposed between the transparent plates 113, 117; and a front absorptive polarizer 119. Upon arriving at the LCD panel assembly 103, the unpolarized light 121 is partially absorbed and partially transmitted. The rear absorptive polarizer 111 acts to absorb light with an undesired plane of polarization and transmit light with a desired plane of polarization. The typical LCD loses over 50% of its initial brightness due to the absorption of light by the rear absorptive polarizer 111. The transparent plates 113, 117 contain an array of thin film transistors T that are configured to apply voltages to the liquid crystal layer 115 on a pixel-by-pixel basis. A portion of the liquid crystal layer 115 corresponding to a pixel rotates the plane of polarization of the light transmitted by the rear absorptive polarizer 111 depending on the voltage applied to it by the transistor T (or transistors) for that pixel. The front polarizer 119 then absorbs light whose plane of polarization has been rotated by the liquid crystal layer 115 and transmits light whose plane of polarization has not been rotated to the viewer. The maximum contrast achievable by the LCD 100 is determined by the polarizers 111, 119. Thus, to produce a desirably high display contrast, the polarizers 111, 119 must have a high contrast ratio (e.g., 1000:1).

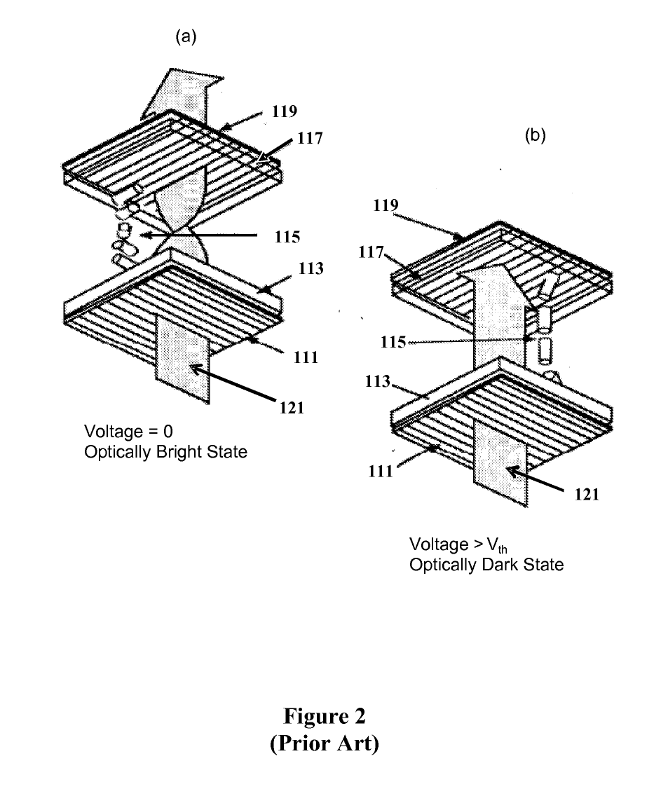

FIG. 2 illustrates the principle behind the operation of an LCD display of the twisted nematic type. In the V=0 state depicted in FIG. 2(a), the long axis of the liquid crystal layer 115 undergoes a 90° twist between the lower transparent plate 113 and the upper transparent plate 117. However, the long axis is always pointing in a plane parallel to the plane of the transparent plates 113, 117. In the Voltage ON condition of FIG. 2(b), the long axis of the liquid crystal layer 115 rotates to point towards the transparent plates 113, 117 by as much as 90°. This change in the orientation of the long axis of a portion of the liquid crystal layer 115 corresponding to an individual pixel causes a rotation of the polarization of light that passes through that pixel. As a result of the rotation of the polarization the pixel state can be changed from “off” to an “on” state or vice versa depending on relative orientations of the polarizing directions of the rear polarizer 111 and front polarizer 119.

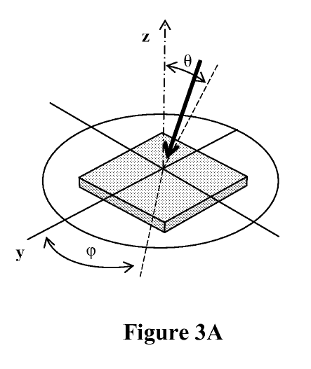

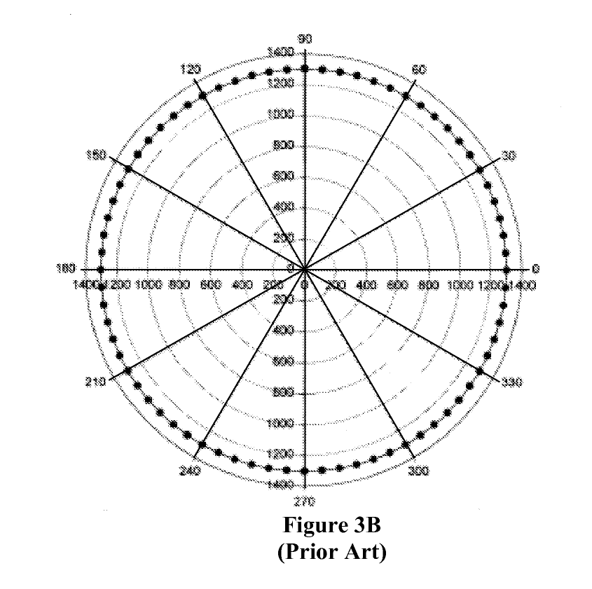

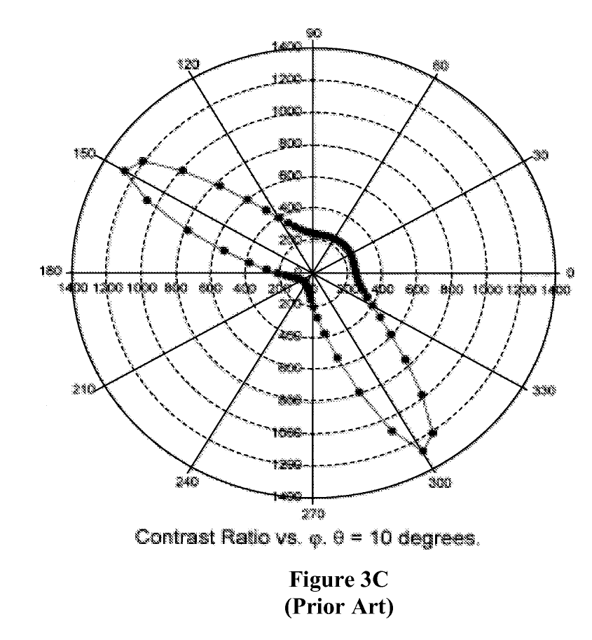

FIGS. 3A-3C illustrate contrast spectra for different viewing angles of a twisted nematic type LCD. The diagram in FIG. 3A illustrates the coordinate system used to analyze contrast ratio. The LCD panel assembly 103 is seen by the viewer at a viewing angle θ, with the contrast ratio being measured at all azimuthal angles φ. When viewing a twisted nematic LCD at normal incidence θ=0° (perpendicular to the surface of the display as indicated in FIG. 3B, the contrast ratio 301 is uniform in all azimuthal angles φ.

However, as illustrated in FIG. 3C, when the twisted nematic LCD is viewed at a viewing angle other than normal incidence θ=10°, the contrast ratio 303 becomes very dependent on azimuthal angle φ. At certain azimuthal angles φ, the contrast ratio 303 falls off significantly, creating poor image quality for the viewer.

While the angular viewing problems associated other types of LCD operating modes such as IPS and OCB are less dramatic than that of the twisted nematic LCD, they still have significant angular viewing issues that must be dealt with. To overcome the viewing angle problem, innovative compensation/retarder films have been developed to effectively cancel the viewing problems by introducing additional layer/layers of material that have substantially the inverse of the optical properties of the liquid crystal layer that produced the undesirable angular viewing problems. Two approaches to the fabrication of compensation films to eliminate or substantially reduce the viewing angle problem of LCDs are described in U.S. Pat. Nos. 4,936,654 and 5,245,456, both if which are incorporated herein by reference. There are four or five manufacturers of compensation films each with their own proprietary method of making compensation films. Types LC and NH are two commonly available varieties of compensation film.

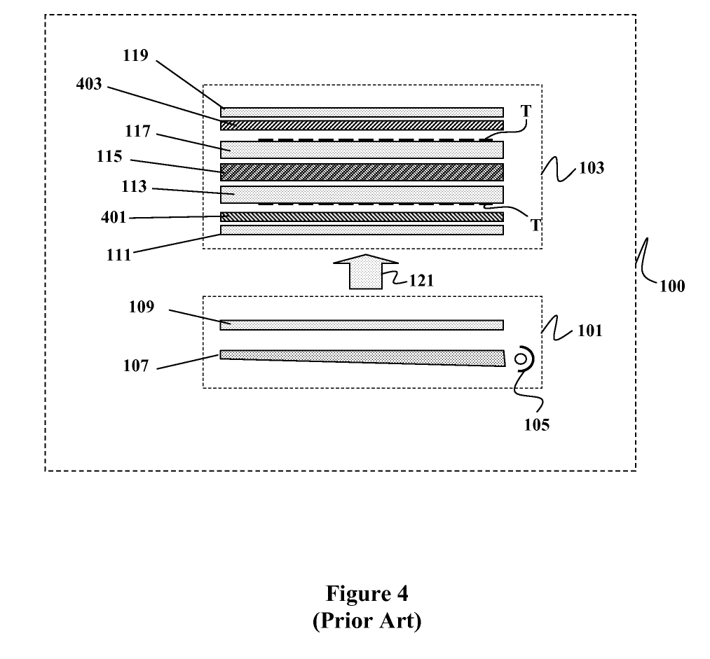

FIG. 4 illustrates the typical construction of an LCD assembly where two compensation films 401, 403 have been added to the basic LCD panel assembly 103. These compensation films 401, 403 decrease the angular viewing problems, but add thickness, complexity, and costs to the production of the LCD 100. To simplify the complexity of the assembly process, certain manufacturers provide polarizers 111, 119 with compensation films 401, 403 laminated to the polarizer (Not shown herein). For example, Nitto Denko Corporation of Osaka Japan supplies a polarizer with a laminated compensation film and LG Chemical of Seoul, South Korea supplies a similar product. While polarizers laminated with a compensation film 401,403 simplify the assembly of an LCD, it does not reduce the thickness or cost of the assembly.

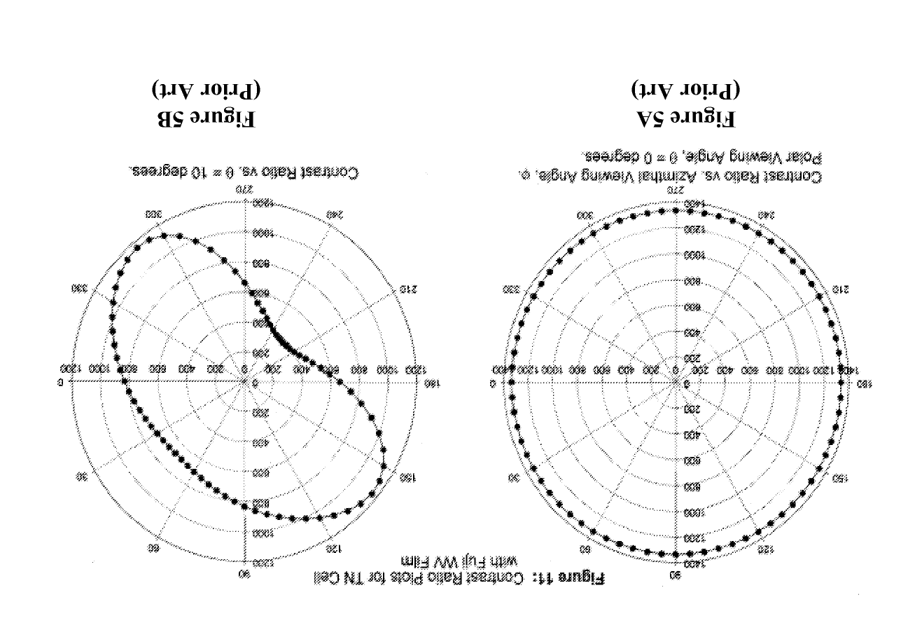

FIGS. 5A-5B illustrate improved contrast spectrum for different viewing angles of a twisted nematic type LCD with the addition of compensation films. As may be seen by comparing FIG. 3B and FIG. 5A, the display contrast ratio 501 at normal incidence is unaffected by the addition of compensation films. The contrast ratio 501 is high and remains uniform across all azimuthal angles φ when the viewing angle is at normal incidence θ=0°. As may be seen by comparing FIG. 5B with FIG. 3C, the off-axis contrast 503 may be improved when the viewing angle is different than normal incidence θ=10°. Although the contrast ratio 503 is not uniform across all azimuthal angles φ, it is significantly improved in comparison to the contrast ratios of the LCD without compensation films (as shown in FIG. 3(b)). In many applications, especially those where the display is to be viewed by more than one person at a time, it is essential that the LCD have this improved angular viewing property.

In addition to the angular viewing problems associated with LCDs, poor optical efficiency (also referred to as brightness) tends to be a pervasive problem as well. As noted earlier, in a typical LCD application, over one half of the light produced by the backlight assembly is absorbed by the rear polarizer and thus not available to the viewer. In order to improve the brightness of LCDs without adding more lamps to the back light (which can make the LCD more complex and costly) or increasing the power consumption of the backlight (which can make the LCD more costly), an innovative new film known as a polarization recycling film has been developed.

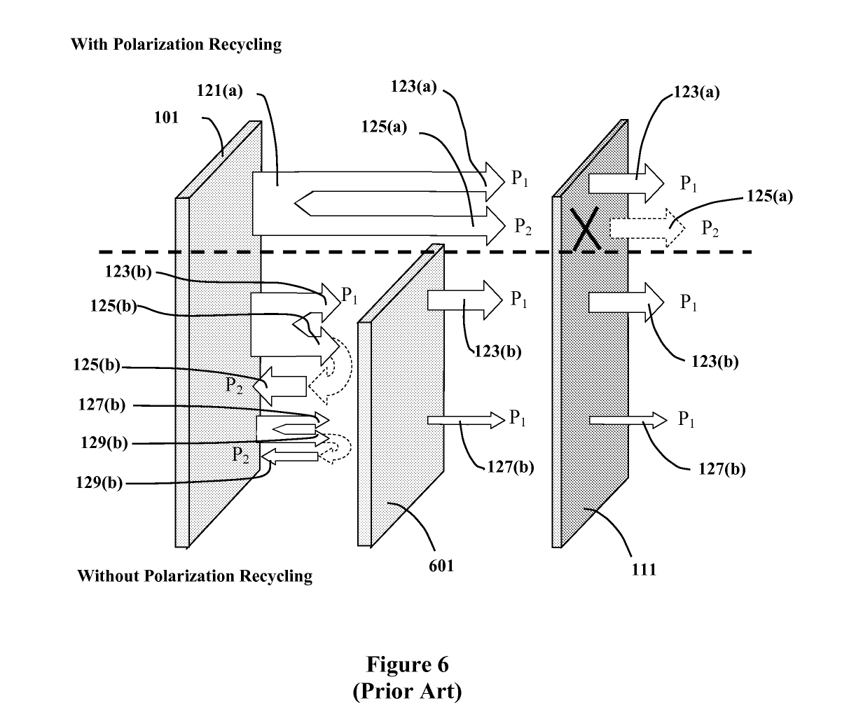

FIG. 6 illustrates the operation of a polarization recycling film. FIG. 6 compares two scenarios: (a) a scenario without polarization recycling and (b) a scenario with polarization recycling.

Considering the scenario without polarization recycling first, the backlight assembly 101 generates unpolarized light 121(a). This unpolarized light 121(a) is composed of two equal amounts of light with orthogonal planes of polarization 123(a), 125(a). The rear absorptive polarizer 111, usually positioned between the backlight assembly 101 and the liquid crystal layer, absorbs light with an undesired plane of polarization 125(a), while transmitting light with a desired plane of polarization 123(a). Without polarization recycling, less than 50% of the light emanating from the backlight assembly 101 reaches the viewer due to absorption by the absorptive polarizer 111.

In the second scenario, polarization recycling is achieved by inserting a polarization recycling film 601 between the backlight assembly 101 and the rear absorptive polarizer 111. As described before, the backlight assembly 101 generates unpolarized light composed of two equal amounts of light with orthogonal planes of polarization 123(b), 125(b). The polarizer recycling film 601 transmits light of the desired plane of polarization 123(b) and reflects light of the undesired plane of polarization 125(b) back towards the backlight assembly 101. The light of the reflected plane of polarization 125(b) undergoes multiple scattering events in the backlight assembly 101, and because the backlight assembly has low absorption, the reflected light 125(b) re-emerges toward the viewer as unpolarized or partially unpolarized light in two equal amounts with orthogonal planes of polarization 127(b), 129(b). A fraction 127(b) of the re-emerging light that is polarized parallel to the plane of high transmission of the reflective polarizer 601 will be transmitted and the remainder 129(b) will be reflected back again to the backlight 101 where upon the process repeats. The light that passes through the polarization recycling film 601 subsequently passes through the rear absorptive polarizer 111 and goes through the processes described above. The net result of the addition of the polarization recycling film 601 is that the sum of the intensity of the components 123(b) and 127(b), and subsequent iterations, is greater than the intensity 123(a) without polarization recycling. Therefore, the brightness that reaches the viewer is much greater when polarization recycling is implemented into the viewing process.

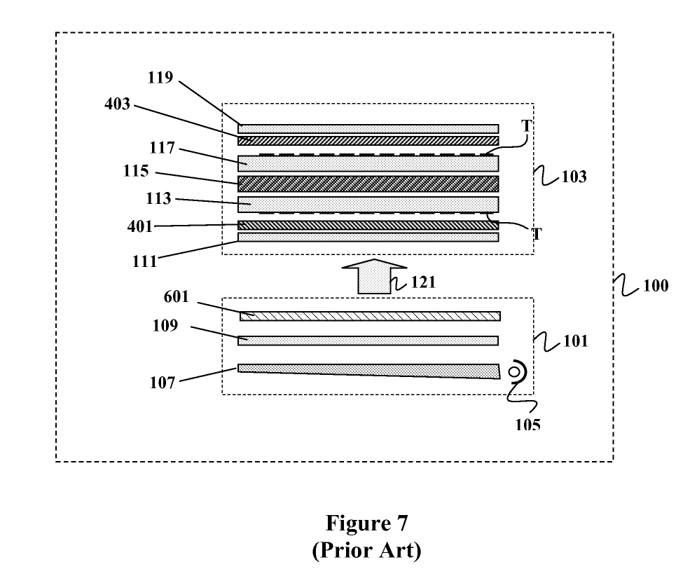

FIG. 7 illustrates the implementation of a polarization recycling film with a typical LCD setup. The functionality of the polarization recycling film 601 was discussed above, along with the overall functionality of the LCD 100. It must be noted that in the polarization-recycling configuration depicted in FIG. 7, the rear absorptive polarizer 111 is not replaced by the polarization recycling film 601. Polarization recycling films 601 have very low contrast and cannot provide the functionality provided by the rear absorptive polarizer 111. Therefore, the benefits of increased brightness that is achieved through the implementation of a polarization recycling film 601, is somewhat negated by the increase in cost, thickness, and assembly complexity of the LCD.

A further innovation in the area of polarization recycling that does not increase the cost, thickness, and complexity of LCDs is the use of high contrast wire grid polarizers as described, e.g., in US Patent Application Publications numbers 20060061862 and 20060118514, both of which are incorporated herein by reference. Wire grid polarizers combine the functionality of an absorptive polarizer and polarization recycling film into one component capable of transmitting light at a high contrast while at the same time reflecting light of an undesired plane of polarization. The wire grid polarizer therefore reduces costs, complexity of assembly, and thickness. However, the wire grid polarizer, by itself, does not account for the angular viewing problems associated with LCDs.

It is therefore desirable to provide a single film that enables (1) wide LCD viewing angles through the use of compensation films; (2) improved LCD brightness through the use of polarization recycling; and (3) the high contrast of an absorptive polarizer through the use of a wire grid polarizer.

An embodiment of a combined functionality film that meets the above objectives is shown in FIG. 8. In the combined functionality film 701, a wire grid polarizer 703 is formed directly on a compensation/retarder film 705. The combined functionality film 701 may replace as many as three separate layers in the LCD (absorptive polarizer, compensation/retarder film, and polarization recycling film) thereby reducing the thickness, cost, and complexity of LCD assemblies. This single combined functionality film 701 meets the objective needs of wide viewing angle and high brightness with the compensation film 705 providing wide viewing angles and the wire grid polarizer 703 providing high contrast and polarization recycling.

The wire grid polarizer 703 may be formed on the compensation/retarder film 705, e.g., by forming the conductive lines of the wire grid polarizer 703 using the compensation/retarder film 705 as a substrate. In embodiments in which the conductive lines of the wire grid polarizer 703 are formed on the compensation/retarder film 705, the combined functionality film 701 may be manufactured in a way that eliminates the need for an additional layer of polymer substrate. Alternatively, the wire grid polarizer 703 may be formed on a polymer substrate, and a compensation/retarder film 705 may be laminated onto the wire grid polarizer 703 to allow for wide viewing angles.

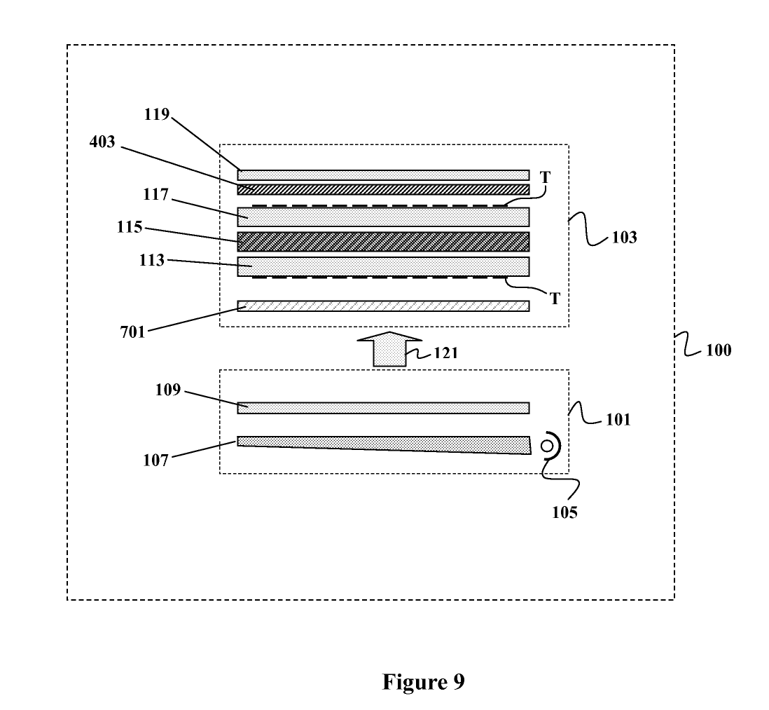

A schematic illustration of one embodiment using this combined functionality film 701 in an LCD is shown in FIG. 9. When compared to FIG. 7, the polarization recycling film 601 has been eliminated as well as the rear absorptive polarizer 111 and the compensation/retarder film 401. By eliminating all of these separate components while retaining all of their functionality through the insertion of a combined functionality film 701, the assembly complexity of the LCD may be simplified while simultaneously reducing its cost and thickness.

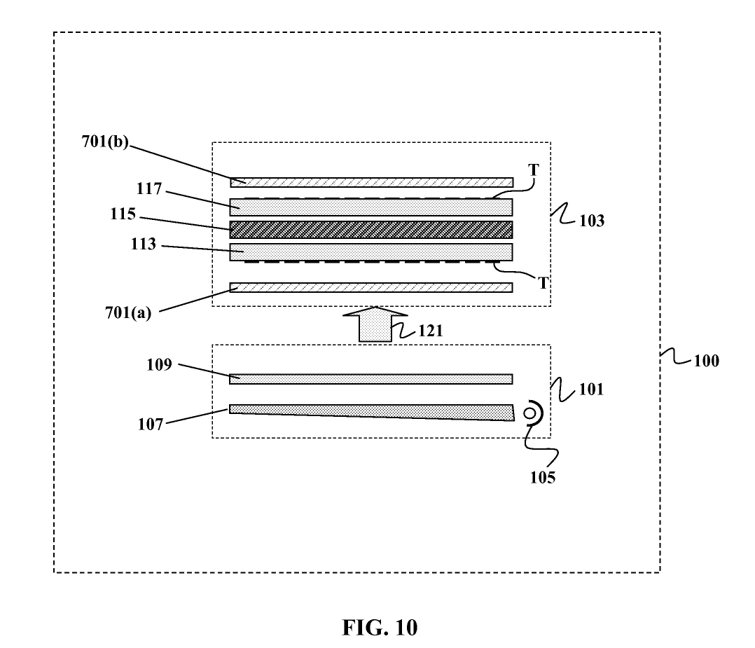

A schematic illustration of a second embodiment using of this combined functionality film 701 in an LCD is shown in FIG. 10. In this embodiment, a combined functionality film 701(a) is used on the rear side of the liquid crystal panel 115 and another combined functionality film 701(b) is used on the front side of the liquid crystal panel 115. The rear side combined functionality film 701(a) replaces the functionality of the polarization recycling film, the compensation/retarder film, and the rear absorptive polarizer. The rear side combined functionality film 701(a) acts to transmit light of the desired plane of polarization while reflecting light of the undesired plane of polarization for polarization recycling, and also acts to widen the viewing angle. The front side combined functionality film 701(b) replaces the functionality of the compensation/retarder film, and the front absorptive polarizer. The combined functionality film 701(b) transmits light of the desired plane of polarization to the viewer and also widens the viewing angle for the viewer. In this configuration it may be desirable to add additional layer/layers to the outer surface of the combined functionality film 701(b) to reduce the reflectivity of the wire grid polarizer that cause viewability problems in high ambient light conditions.

As may be seen from the foregoing, embodiments of the present invention provide for liquid crystal displays having both high brightness and wide viewing angle while reducing the cost of manufacture.

While the above is a complete description of the preferred embodiment of the present invention, it is possible to use various alternatives, modifications, and equivalents.

Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A combined functionality film, comprising:
a) a retarder film or compensation film configured to increase an angular viewing angle for a liquid crystal display; and
b) a wire gird polarizer formed onto a surface of the retarder or compensation film, wherein the wire grid polarizer is configured to transmit light of a desired polarization and reflect light of an undesired polarization.

2. The combined functionality film of claim 1 wherein the wire grid polarizer includes a plurality of parallel electrically conductive lines formed directly on a polymer substrate and wherein the polymer substrate is laminated to the retarder or compensation film.

3. The combined functionality film of claim 1 wherein the wire grid polarizer includes a plurality of parallel electrically conductive lines formed directly on a surface of the retarder or compensation film.

4. The combined functionality film of claim 2, wherein the wire grid polarizer includes nanoscale ridge structures and valley structures formed on the retarder or compensation film and electrically conductive lines formed on the ridge structures but not the valley structures.

5. The combined functionality film of claim 1, wherein the wire grid polarizer includes a plurality of regularly spaced metal lines characterized by a periodicity in the range of 50 nm to 250 nm.

6. The combined functionality film of claim 5, wherein the electrically conductive lines are made of aluminum.

7. A liquid crystal display (LCD) comprising:
a) a backlight unit configured to create unpolarized illumination and process reflected illumination of a polarization orthogonal to the desired polarization so that the reflected illumination re-emerges from the backlight unit as unpolarized illumination; and
b) an LCD panel assembly configured to transmit a desired image to a viewer, wherein the LCD panel assembly includes a multifunction film comprising a wire grid polarizer formed on a surface of a retarder film or compensation film, wherein the wire grid polarizer is configured to transmit light of a desired plane of polarization from the backlight unit and reflect light of an undesired plane of polarization from the backlight unit, and wherein the retarder film or compensation film is configured to increase a viewing angle of the liquid crystal display.

8. The LCD of claim 7, wherein the backlight unit includes a light source configured to create unpolarized light.

9. The LCD of claim 8, wherein the LCD panel assembly includes a liquid crystal layer configured to rotate the plane of polarization of light of a desired plane of polarization on a pixel-by-pixel basis dependent on the voltage applied to each pixel.

10. The LCD of claim 9, wherein the backlight unit includes a light guide configured to direct unpolarized light emanating from the light source.

11. The LCD of claim 9, wherein backlight unit includes a diffuser configured to homogenize spatial variations in the intensity of the light emanating from the light source.

12. The LCD of claim 9, wherein LCD panel assembly includes a liquid crystal layer disposed between first and second transparent plates, wherein each transparent plate contains an array of thin film transistors configured to apply voltages to portions of the liquid crystal layer on a pixel-by-pixel basis.

13. The LCD of claim 12 wherein the first or second transparent plate is disposed between liquid crystal layer and the multifunction film.

14. The LCD of claim 12 further comprising an additional multifunction film comprising a wire grid polarizer formed directly on a surface of a retarder film or compensation film, wherein the first and second transparent plates are disposed between the multifunction film and the additional multifunction film.

15. The LCD of claim 9, further comprising a second multifunction film between the liquid crystal layer and the viewer, configured to transmit light with a desired plane of polarization and widen viewing angles.

16. The LCD of claim 7, wherein the wire grid polarizer includes a plurality of parallel electrically conductive lines formed on a polymer substrate and wherein the polymer substrate is laminated to the retarder or compensation film.

17. The LCD of claim 7, wherein the wire grid polarizer includes a plurality of parallel electrically conductive lines formed directly on a surface of the retarder or compensation film.

18. The LCD of claim 17, wherein the wire grid polarizer includes nanoscale ridge structures and valley structures formed on the retarder or compensation film and metal lines formed on the ridge structures but not the valley structures.

19. The LCD of claim 7, wherein the wire grid polarizer includes a plurality of regularly spaced metal lines characterized by a periodicity in the range of 50 nm to 250 nm.

20. The LCD of claim 7, wherein the electrically conductive lines are made of aluminum.

21. An liquid crystal display (LCD) panel assembly, comprising
a liquid crystal layer disposed between first and second transparent plates, wherein each transparent plate contains an array of thin film transistors configured to apply voltages to portions of the liquid crystal layer on a pixel-by-pixel basis;
a multifunction film comprising a wire grid polarizer formed on a surface of a retarder film or compensation film, wherein the wire grid polarizer is configured to transmit light of a desired plane of polarization from the backlight unit and reflect light of an undesired plane of polarization from the backlight unit, and wherein the retarder film or compensation film is configured to increase a viewing angle of a liquid crystal display made using the LCD panel assembly.

22. The LCD panel assembly of claim 21, wherein the first or second transparent plate is disposed between liquid crystal layer and the multifunction film.

23. The LCD panel assembly of claim 22 further comprising an additional multifunction film comprising a wire grid polarizer formed on a surface of a retarder film or compensation film, wherein the first and second transparent plates are disposed between the multifunction film and the additional multifunction film.

24. The LCD panel assembly of claim 21, wherein the wire grid polarizer includes a plurality of parallel electrically conductive lines formed on a polymer substrate and wherein the polymer substrate is laminated to the retarder or compensation film.

25. The LCD panel assembly of claim 21, wherein the wire grid polarizer includes a plurality of parallel electrically conductive lines formed directly on a surface of the retarder or compensation film.
